(19) United States
(12) Patent Application Publication
(10) Pub. No.: US 2010/0143164 A1
(43) Pub. Date: Jun. 10, 2010

(54) FAN MOTOR STRUCTURE

(75) Inventors: Guo-Jhih YAN, Kaohsiung City (TW); Guang-Miao HUANG, Kaohsiung City (TW); Hsing-Chih TSAI, Kaohsiung City (TW); Hsin-Te WANG, Jhonghe City (TW); Liang-Yi HSU, Makung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: METAL INDUSTRIES RESEARCH & DEVELOPMENT CENTRE, Kaohsiung (TW)

(21) Appl. No.: 12/345,805

(22) Filed: Dec. 30, 2008

(30) Foreign Application Priority Data
Dec. 10, 2008 (TW) 097148013

(51) Int. Cl. F04D 25/12; H02K 21/24

(52) U.S. Cl. 417/356; 310/156.32

(57) ABSTRACT

A fan motor structure is provided. A fan is disposed within an accommodating hole at a center of a body. A permanent magnet and a printed circuit board (PCB) provided with plural coils are respectively disposed between an upper ring and a base of the body. An axial air gap is formed between the coils and the permanent magnet. A bearing is disposed between the upper ring and the base. The fan blades of the fan extend from the periphery of the accommodating hole toward the center of the fan. An axle center of the fan overlaps with that of the body. The coils after being supplied with a current create a flux linkage with the permanent magnet. Due to the flux linkage and the axial air gap between the coils and the permanent magnet, the upper ring is forced to rotate, thus driving the fan to rotate.

### CROSS-REFERENCE TO RELATED APPLICATION

This application claims the benefit of Taiwan Patent Application No. 097148013, filed on Dec. 10, 2008, which is hereby incorporated by reference for all purposes as if fully set forth herein.

### BACKGROUND OF THE INVENTION

1. Field of the Invention

The present invention relates to a fan motor structure, and more particularly to a fan motor structure in which a motor is in an axial air gap and axial flux type, a fan is disposed at a central position within the annular motor, and coils and circuits are laid out on a printed circuit board (PCB), so as to achieve a miniaturized structure.

2. Related Art

Among conventional fan motor designs, Taiwan Utility Model Publication No. 433719 discloses an “Improved Structure of a Heat Dissipation Fan (␣)” (as shown in FIG. 5). It can be seen from a fan structure disclosed in this patent that the existing fan motor designs all adopt the external rotor type in which a stator is disposed inside and a rotor is disposed outside. As disclosed in this patent, a fan motor 6 has a hollow housing base 61. The housing base 61 is provided therein with a stator 62 formed by silicon steel sheets winding with coils and a fan rotor 63 pivotedly disposed with a position relative to the stator 62. The fan rotor 63 has a hollow shaft seat 64 that can be sleeved on an outer side of the stator 62. The shaft seat 64 is pivoted to the housing base 61 by a central shaft. A plurality of fan blades 65 extends from an outer circumferential surface of the shaft seat 64. A permanent magnet 66 formed by different magnetic polarities that are alternately arranged is attached to an inner edge of the shaft seat 64. In addition, the housing base 61 may be mounted with a cover plate 67 at a top thereof. The cover plate 67 is provided with a through hole 68 of a size corresponding to the fan rotor 63 at a center thereof.

The fan motor 6 disclosed above provides a means for heat dissipation. However, since the silicon steel sheets of the stator of this fan motor structure are integrally formed, when it is desired to wind coils on outer end portions of the silicon steel sheets extending in four different directions, the operation is hindered by neighboring coils, so that the winding is difficult to operate. In addition, since such a fan motor is designed as an external rotor structure in which a stator is disposed inside and a rotor is disposed outside, the air volume generated by the rotation of the fan is reduced. Moreover, the fan motor rotates the fan by electrifying the coils on the stator to generate a magnetic field and thus causing an interaction force between the coils and the magnet on the rotor. Since the temperature of the coils of the stator rises after the coils are electrified to generate a magnetic field, the stator of the fan motor adopts a built-in design, and the shaft casing at the center of the fan blades is sleeved on the outer side of the stator. Thereby, the heat generated by the stator cannot be effectively dissipated, resulting in a reduction of the performance and the service life of the fan motor due to high temperature. Hence, the motor structure needs to be improved.

Directed to the disadvantages of the above external rotor structure, a structure of another fan motor 7 (as shown in FIG. 6) is provided for improvement. The fan motor 7 includes a rotor 72 for rotating a rotating shaft and a stator 71 for rotating the rotor 72. The rotor 72 is disposed within the stator 71, and spaced from the stator 71 by an air gap.

The stator 71 includes a stator iron core 711 formed by laminating a plurality of disc-shaped steel sheets together. An accommodating hole 712 is formed at a center of the stator 71, and the rotor 72 is disposed within the accommodating hole 712. When the rotor 72 is disposed within the accommodating hole 712, the rotor 72 is separated from an inner circumference of the stator iron core 711 by the air gap. Teeth and slots are alternately formed along a circumference of the accommodating hole 712. A stator coil is wound around the teeth, and generates a magnetic force for rotating the rotor 72 when an electric current is applied thereto.

The rotor 72 includes a rotating shaft 721 and a permanent magnet 722. The permanent magnet 722 is connected to the rotating shaft 721 and rotates the rotor 72. The permanent magnet 722 is ring-shaped, and has a magnetic field that flows in a radial direction of the rotating shaft 721. A bearing 723 is connected to the rotating shaft 721 to rotatably support the rotating shaft 721.

The stator 71 is disposed in a housing 73. The housing 73 is made of a synthetic resin, such as a bulk molding compound. The housing 73 also includes a printed circuit board (PCB) (not shown). A driving circuit, such as a driving integrated circuit (IC), is provided on the PCB.

One of the disadvantages of such a fan motor lies in that the existence of the PCB and the driving IC in the housing requires the width of the housing to be increased in the axial direction of the motor. In addition, since the stator coil protrudes above the stator iron core by a height, the width of the housing required in the axial direction of the motor is also increased. Moreover, since the stator iron core is formed by laminating the plurality of steel sheets in an axial direction, eddy current loss occurs due to axial flux, which reduces the efficiency of the fan motor.

Therefore, how to achieve the microminiaturization and thinness of the fan motor while maintaining the efficiency of the motor and the performance of the fan so as to simplify the parts and facilitate the manufacture and assembly is a problem in urgent need of solutions in the field of fan motor.

### SUMMARY OF THE INVENTION

Accordingly, the present invention is directed to a fan motor structure, in which a motor in an axial air gap and axial flux type is used, and coils and circuits are laid out on a printed circuit board (PCB), so as to achieve a miniaturized structure while maintaining the efficiency of the motor.

The present invention is also directed to a fan motor structure, in which a fan is disposed at a central position within a motor, so as to achieve a miniaturized motor structure while maintaining the performance of the fan.

In order to achieve the above objectives, a fan motor structure including a body, a bearing, and a fan is provided. The body is formed with an accommodating hole at a center thereof and includes an upper ring and a base. A permanent magnet is disposed on one side of the upper ring relative to the base. A PCB is disposed at the base relative to the permanent magnet. The PCB is provided thereon with a plurality of coils capable of creating a flux linkage with the permanent magnet after being supplied with a current. An axial air gap is formed between the coils and the permanent magnet. The bearing is disposed between the upper ring and the base. The fan is disposed within the accommodating hole and has a plurality of blades. The fan blades extend from the periphery of the accommodating hole toward the center of the fan and are equiangularly spaced from each other.

The coils after being supplied with a current create a flux linkage with the permanent magnet, such that the upper ring is forced to rotate, thus driving the fan to rotate.

Preferably, the base is provided with a central shaft protruding toward the upper ring. An axle center of the central shaft overlaps with that of the body. The fan further has an outer frame and a hollow annular inner frame. The fan blades are disposed between the outer frame and the inner frame. The central shaft of the base penetrates the inner frame of the fan.

Preferably, the base has a through hole. An axle center of the through hole overlaps with that of the body. The fan is provided with a rotating shaft protruding downward from the center thereof. The fan blades are disposed between the outer frame and the rotating shaft. The rotating shaft of the fan penetrates the through hole of the base, such that the axle center of the through hole overlaps with that of the body.

Preferably, the bearing is a ball bearing.

Preferably, the bearing is a fluid dynamic lubricated bearing.

Therefore, in the present invention, with the above structure, the miniaturized motor structure is achieved, and meanwhile the performance of the fan and the efficiency of the motor are maintained.

The detailed features and advantages of the present invention are described below in great detail through the following embodiments, the content of the detailed description is sufficient for those skilled in the art to understand the technical content of the present invention and to implement the present invention there accordingly. Based upon the disclosure of the specification, claims, and drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus are not limitative of the present invention, and wherein:

FIG. 1 is a schematic cross-sectional view of a first embodiment of the present invention;

FIG. 2 is a schematic cross-sectional view of a second embodiment of the present invention;

FIG. 3 is a schematic cross-sectional view of a third embodiment of the present invention;

FIG. 4 is a schematic cross-sectional view of a fourth embodiment of the present invention;

FIG. 5 is a cross-sectional view of a conventional fan motor structure; and

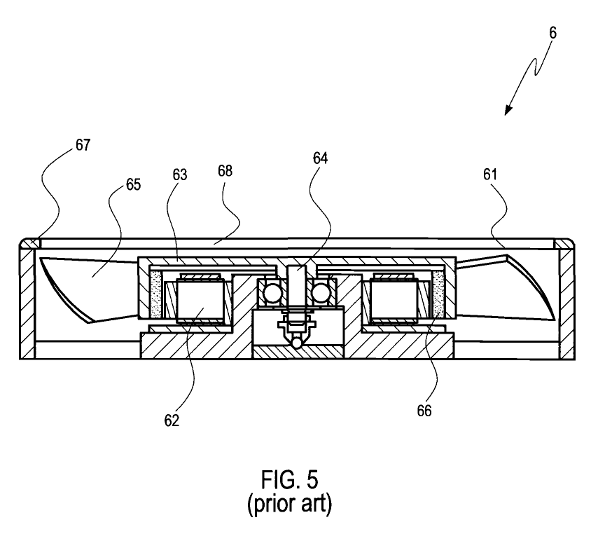

FIG. 6 is a cross-sectional view of another conventional fan motor structure.

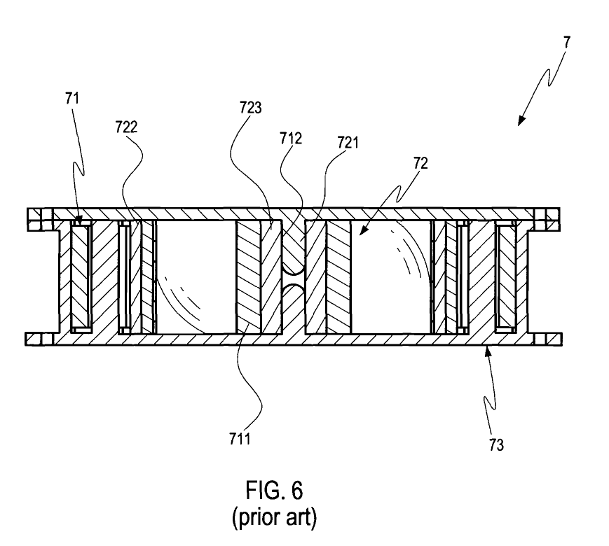

### DETAILED DESCRIPTION OF THE INVENTION

Preferred embodiments of the present invention are described in detail below with the accompanying drawings.

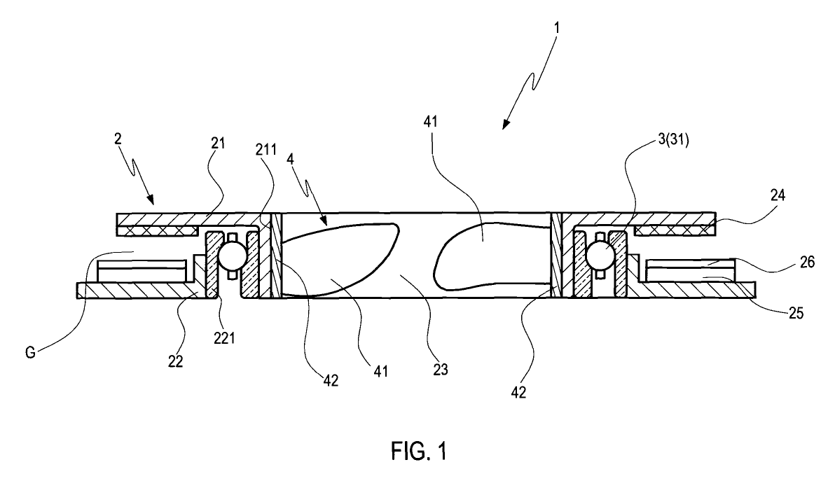

FIG. 1 is a schematic cross-sectional view of a first embodiment of the present invention. Referring to FIG. 1, a fan motor structure 1 of this embodiment includes a body 2, a bearing 3, and a fan 4.

The body 2 has an accommodating hole 23 at a center thereof and includes an upper ring 21 and a base 22. In this embodiment, the base 22 is ring-shaped. The bearing 3 is disposed between the upper ring 21 and the base 22 and adjacent to the accommodating hole 23. A permanent magnet 24 is disposed adjacent to an outer edge of the upper ring 21 and on one side of the upper ring 21 adjacent to the base 22. The permanent magnet 24 is a magnet ring. A printed circuit board (PCB) 25 is disposed adjacent to an outer edge of the base 22 and relative to the permanent magnet 24. The PCB 25 is provided thereon with a plurality of coils 26. An axial air gap G is formed between the base 22 and the permanent magnet 24 in an axial direction of the motor 1, such that the base 22 and the permanent magnet 24 are separated from each other. That is, the axial air gap G is formed between the coils 26 and the permanent magnet 24.

The bearing 3 is disposed between the upper ring 21 and the base 22 and adjacent to the accommodating hole 23, such that the upper ring 21 and the base 22 are spaced from each other, and the upper ring 21 rotates relative to the base 22 with the bearing 3. In this embodiment, the bearing 3 is a ball bearing 31. However, it is understood that the bearing 3 may also be a fluid dynamic lubricated bearing, which will be described in detail below in a fourth embodiment.

In this embodiment, the bearing 3 is disposed adjacent to the accommodating hole 23, and the permanent magnet 24 and the PCB 25 are respectively disposed adjacent to the outer edge of the upper ring 21 and the outer edge of the base 22. However, according to use requirements, the bearing 3 may also be disposed adjacent to the outer edge of the upper ring 21 and the outer edge of the base 22, and the permanent magnet 24 and the PCB 25 may also be respectively disposed at the upper ring 21 and the base 22 adjacent to the accommodating hole 23.

The fan 4 is disposed within the accommodating hole 23 of the body 2. Fan blades 41 of the fan 4 extend from the periphery of the accommodating hole 23 toward a center of the motor. An outer frame 42 of the fan blades 41 is disposed at an inner wall 211 of the upper ring 21. Preferably, an inner diameter of the upper ring 21 is slightly smaller than that of the base 22, so that the outer frame 42 of the fan blades 41 does not contact an inner wall 221 of the base 22. In addition, an axle center of the fan 4 overlaps with that of the body 2.

Relative to a conventional fan motor structure, the upper ring is a rotor, and the base is a stator. When the coils 26 on the PCB 25 are electrified, the coils 26 create a flux linkage with the permanent magnet 24. Due to the flux linkage and the presence of the axial air gap G between the base 22 and the permanent magnet 24, the upper ring 21 (rotor) is forced to rotate, thus driving the fan 4 to rotate.

As the design of the axial air gap G in the fan motor 1 facilitates the miniaturization and the cogging effect caused by iron core teeth and slots is also eliminated due to no longer using silicon steel sheets, the motor of the present invention is smaller, lighter, and operates more stably than a conventional motor under the same power level, thus achieving the miniaturized motor structure. Besides, the structure of this embodiment is simple, and is easy to manufacture and assemble. Moreover, as the coils are laid out on the PCB in the present invention, compared with the conventional wound coils, they are easy to be implemented in a micro-space. The stator copper loss is reduced by adjusting the lead width, and iron loss is avoided as the iron cores in the conventional motor are no longer used. In addition, the magnetic pull force between the rotor and stator is reduced through proper designs, such that the load of the bearing is reduced, and the mechanical loss of the motor is accordingly lowered, thus further maintaining the efficiency of the fan motor.

In addition, as the axle center of the fan 4 overlaps with that of the body 2, that is, the axle center of the fan 4 overlaps with that of the upper ring 21 (and the base 22), when the upper ring 21 rotates and thus drives the fan 4 to rotate, the friction and loss caused by oscillation as well as the reduction in the power of the motor resulted therefrom are prevented.

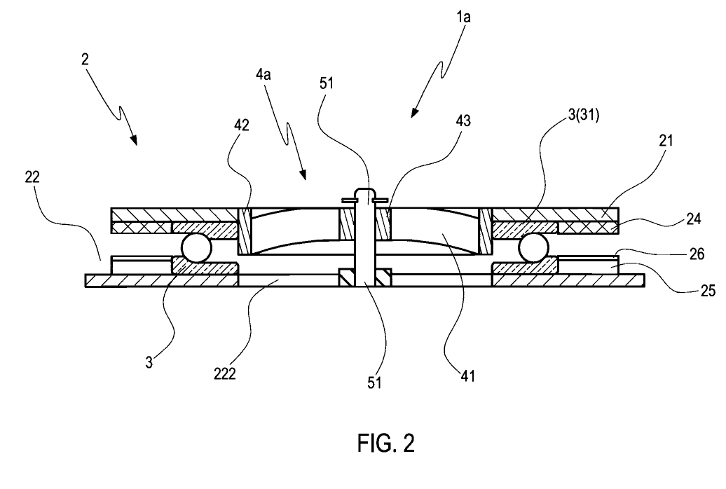

FIG. 2 is a schematic cross-sectional view of a second embodiment of the present invention. Referring to FIG. 2, a fan motor structure 1a of this embodiment is similar to the fan motor structure 1 of the first embodiment, so that the same reference numbers are used to indicate the same parts.

In the fan motor structure 1 a of this embodiment, the base 22 is provided with a central shaft 51 protruding from a center thereof. An axle center of the central shaft 51 overlaps with that of the body 2. The base 22 is provided with a plurality of air vents 222 corresponding to the accommodating hole 23 of the body 2 for air circulation. The bearing 3 is disposed between the upper ring 21 and the base 22 and adjacent to the accommodating hole 23, such that the upper ring 21 and the base 22 are spaced from each other, and the upper ring 21 rotates relative to the base 22 with the bearing 3.

A fan 4a of this embodiment further has a hollow annular inner frame 43. The fan blades 41 are disposed between the outer frame 42 and the inner frame 43. The central shaft 51 of the base 22 penetrates the inner frame 43 of the fan 4a, such that the fan 4a is coaxial with the body 2. Therefore, when the upper ring 21 (rotor) rotates, the upper ring 21 rotates coaxially with the fan 4a, and thus the reduction in the power of the motor caused by oscillation during rotation is avoided. The central shaft 51 is provided with a C-shaped snap ring at a top end thereof to prevent detachment of the fan 4a and the base 22 during rotation.

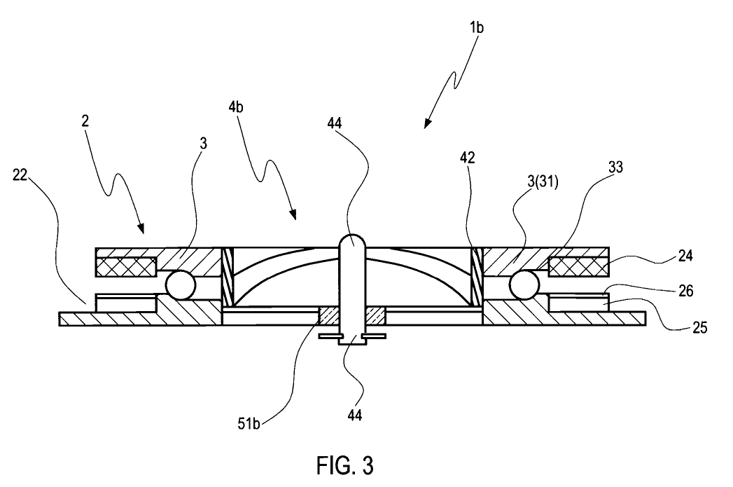

FIG. 3 is a schematic cross-sectional view of a third embodiment of the present invention. Referring to FIG. 3, a fan motor structure 1b of this embodiment is similar to the fan motor structure 1a of the second embodiment, so that the same reference numbers are used to indicate the same parts.

In the fan motor structure 1b of this embodiment, the base 22 is provided with a through hole 51b at the center thereof. An axle center of the through hole 51b overlaps with that of the body 2. The bearing 3 is annularly disposed between the upper ring 21 and the base 22 and adjacent to the accommodating hole 23, an inner ring of the bearing 3 in the second embodiment is integrally formed with the upper ring 21, and an outer ring of the bearing 3 in the second embodiment is integrally formed with the base 22, such that the upper ring 21 and the base 22 are spaced from each other, and the upper ring 21 rotates relative to the base 22 with the bearing 3. The fan 4b of this embodiment further has a rotating shaft 44. The fan blades 41 are disposed between the outer frame 42 and the rotating shaft 44. The rotating shaft 44 penetrates the through hole 51b of the base 22, and the fan 4b is coaxial with the body 2. Therefore, when the upper ring 21 (rotor) rotates, the upper ring 21 rotates coaxially with the fan 4b, so that the reduction in the power of the motor caused by oscillation during rotation is avoided.

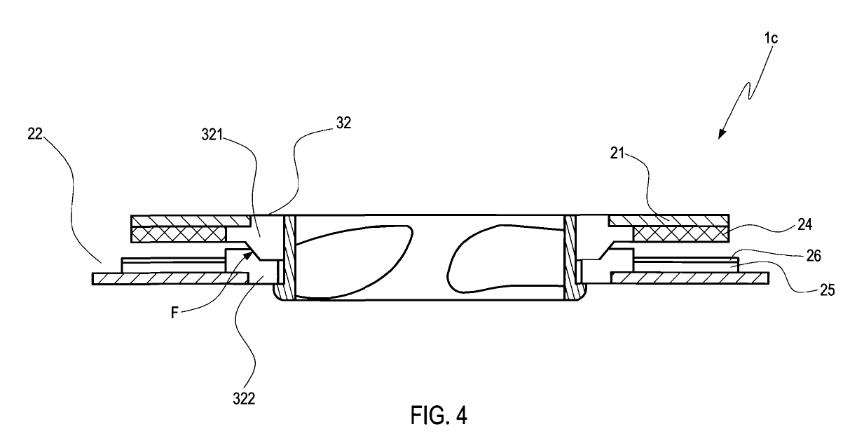

FIG. 4 is a schematic cross-sectional view of a fourth embodiment of the present invention. Referring to FIG. 4, a fan motor structure 1c of this embodiment is similar to the fan motor structure 1b of the third embodiment, so that the same reference numbers are used to indicate the same parts.

The bearing 3 of this embodiment is a fluid dynamic lubricated bearing 32. The fluid dynamic lubricated bearing 32 has a ridge-shaped protruding portion 321 and a V-shaped recessed portion 322. The ridge-shaped protruding portion 321 is disposed at the upper ring 21, and the V-shaped recessed portion 322 is disposed at the base 22. The ridge-shaped protruding portion 321 is disposed within the V-shaped recessed portion 322. A lubricating fluid F is injected between the ridge-shaped protruding portion 321 and the V-shaped recessed portion 322. In a stationary state, a sealing effect is achieved by surface tension interaction between the lubricating fluid F and an air contact surface. During rotation, a flow passage (not shown) at the contact surface between the V-shaped recessed portion 322 and the ridge-shaped protruding portion 321 is designed so as to control the pressure of the lubricating fluid F in the flow passage. An oil tank (not shown) in the V-shaped recessed portion 322 prevents leakage of the fluid F. Meanwhile, the reduction in the power of the motor caused by oscillation and friction during rotation is avoided.

Therefore, in the present invention, with the above structure, not only the miniaturized motor structure of the fan motor is achieved, but also the fan motor is easy to manufacture and assemble due to its simple structure. Moreover, as the fan is coaxial with the body 2 of the motor, when the upper ring 21 (rotor) drives the fan to rotate, no oscillation and friction are caused, and thus the power of the motor is not reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fan motor structure, comprising:
a body having an accommodating hole and formed by an upper ring and a base, wherein a permanent magnet is disposed on one side of the upper ring relative to the base, a printed circuit board (PCB) is disposed at the base relative to the permanent magnet, the PCB is provided thereon with a plurality of coils;
a bearing disposed between the upper ring and the base; and
a fan disposed within the accommodating hole and having a plurality of fan blades, wherein the fan blades extend from periphery of the accommodating hole toward a center of the fan.

2. The fan motor structure according to claim 1, wherein the fan further has an outer frame disposed at an inner wall of the upper ring, and the fan blades extend from the outer frame toward the center of the fan.

3. The fan motor structure according to claim 2, wherein the fan further has a hollow annular inner frame, and the fan blades are disposed between the outer frame and the inner frame and equiangularly spaced from each other.

4. The fan motor structure according to claim 3, wherein the base is provided with a central shaft protruding toward the upper ring, an axle center of the central shaft overlaps with an axle center of the body, and the central shaft penetrates the inner frame of the fan.

5. The fan motor structure according to claim 2, wherein the fan further has a rotating shaft, and the fan blades are disposed between the outer frame and the rotating shaft.

6. The fan motor structure according to claim 4, wherein the base is provided with a plurality of air vents relative to the accommodating hole.

7. The fan motor structure according to claim 5, wherein the base is provided with a plurality of air vents relative to the accommodating hole.

8. The fan motor structure according to claim 5, wherein the base has a through hole, and the rotating shaft of the fan penetrates the through hole of the base.

9. The fan motor structure according to claim 1, wherein the bearing is disposed between the upper ring and the base and adjacent to the accommodating hole of the body.

10. The fan motor structure according to claim 2, wherein the bearing is disposed between the upper ring and the base and adjacent to the accommodating hole of the body.

11. The fan motor structure according to claim 1, wherein the bearing is disposed between the upper ring and the base and adjacent to an outer edge of the body.

12. The fan motor structure according to claim 2, wherein the bearing is disposed between the upper ring and the base and adjacent to an outer edge of the body.

13. The fan motor structure according to claim 9, wherein the bearing is selected from a group consisting of a ball bearing or a fluid dynamic lubricated bearing.

14. The fan motor structure according to claim 10, wherein the bearing is selected from a group consisting of a ball bearing or a fluid dynamic lubricated bearing.

15. The fan motor structure according to claim 11, wherein the bearing is selected from a group consisting of a ball bearing or a fluid dynamic lubricated bearing.

16. The fan motor structure according to claim 12, wherein the bearing is selected from a group consisting of a ball bearing or a fluid dynamic lubricated bearing.

17. The fan motor structure according to claim 1, wherein the coils after being supplied with a current create a flux linkage with the permanent magnet, and an axial air gap is formed between the coils and the permanent magnet, the flux linkage and the axial air gap force the upper ring to rotate so as to drive the fan to rotate.
